(19) United States
(12) Patent Application Publication
(10) Pub. No.: US 2003/0193904 A1
(43) Pub. Date: Oct. 16, 2003

(54) WDM network design system, method and program thereof

(75) Inventor: Kenji Soga, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/409,780

(22) Filed: Apr. 8, 2003

(30) Foreign Application Priority Data
Apr. 10, 2002 (JP) 107243/2002

(51) Int. Cl. H04L 12/26

(52) U.S. Cl. 370/254; 370/252; 370/238

(57) ABSTRACT

To the design data input means 11 are inputted data of equipment candidates capable of being disposed, predictive demands and design parameters. The path candidate design means 12 designs a plurality of candidates of paths accommodating predictive demands by disposable equipment candidate based on the input data. The path candidate combination design means 13 selects a combination of adequate paths among path candidates designed in the path candidate design means 12 by using a genetic algorithm in such a way as to permit an inexpensive WDM network to be built up. The equipment disposition output means 14 outputs a disposition of equipment accommodating the path combination selected in the path candidate combination design means 13.

### BACKGROUND OF THE INVENTION

This application claims benefit of Japanese Patent Application No. 2002-107243 filed on Apr. 10, 2002, the contents of which are incorporated by the reference.

The present invention relates to WDM (Wavelength Division Multiplexing) network design systems, WDM network design methods used therein and programs for such systems and methods and, more particularly, to methods of path design.

As prior art path design method, Japanese Patent Laid-Open No. 7-250356 discloses a method of setting paths such as to minimize the number of accommodated paths (hereinafter referred to as first prior art).

In such path design, it is possible to accommodate paths without being collected in one place but in a dispersed fashion. Thus, when it is intended to accommodate paths in an existing equipment, the necessary number of wavelengths can be reduced, permitting accommodation of an increased number of paths.

Japanese Patent Laid-Open No. 7-202844 discloses a method of obtaining a best combination of paths by producing a plurality of path candidates (hereinafter referred to as second prior art).

However, in the case of using the first prior art in the prior art path design system, it is usually necessary to construct a new equipment and build up a new network. This means that the provided equipment is dispersedly disposed, and more equipment is dictated, which is economically undesired.

In the case of using the second prior art, paths are randomly combined. Therefore, unless the number of times of repetition is increased, a solution closer to the best one cannot be obtained, and doing so takes extremely long design time.

### SUMMARY OF THE INVENTION

An object of the present invention is to provide a WDM network design system and a WDM network design method and programs used for the same system capable of solving the above problems and quick design of better combination even with a large-scale problem.

According to an aspect of the present invention, there is provided a WDM (wavelength division multiplexing) network design system comprising a path candidate design means for generating a gene array by design a plurality of candidates of paths for accommodating predictive demands by using a disposable equipment candidate, and a path candidate combination design means for selecting an appropriate path combination from path candidates designed in path candidate design by using a genetic algorithm for the optimal solution of a given problem by executing a genetic operation with respect to the generated gene array.

According to another aspect of the present invention, there is provided a WDM (wavelength division multiplexing) network design method comprising steps of a path candidate design step for generating a gene array by design a plurality of candidates of paths for accommodating predictive demands by using a disposable equipment candidate, and a path candidate combination design step for selecting an appropriate path combination from path candidates designed in path candidate design by using a genetic algorithm for the optimal solution of a given problem by executing a genetic operation with respect to the generated gene array.

According to other aspect of the present invention, there is provided a program for executing steps of a path candidate design step for generating a gene array by design a plurality of candidates of paths for accommodating predictive demands by using a disposable equipment candidate, and a path candidate combination design step for selecting an appropriate path combination from path candidates designed in path candidate design by using a genetic algorithm for the optimal solution of a given problem by executing a genetic operation with respect to the generated gene array.

Specifically, the WDM network design system according to the present invention can provide an inexpensive WDM (wavelength division multiplexing) network for accommodating predictive demands.

In greater details, in the WDM network design system according to the present invention, data of equipment candidate capable of being disposed with design data input, predictive demands and design parameters are inputted, a plurality of predictive demand accommodation path candidates are designed by using disposable equipment candidates in the path candidate design, and an appropriate path combination is selected from path candidates designed in path candidate design by using a genetic algorithm in such a way as to permit an inexpensive WDM network to be built up. An equipment disposition for accommodating the path combination selected in path candidate combination design is outputted from equipment disposition output.

As shown, in the WDM network design system according to the present invention, a plurality of path candidates are designed in the path candidate design, and the best path combination is selected in the path candidate combination design. It is thus possible to design a WDM network based on inexpensive equipment disposition.

While the path candidate combination design involves solving of a combination problem, by using a genetic algorithm it is possible to quickly find out a relatively good solution even in a large topology.

By the term “genetic algorithm” is meant a method of obtaining the optimal solution of a given problem by using a genetic operation provided with a hint obtained in the process of evolution of an organism.

Other objects and features will be clarified from the following description with reference to attached drawings.

### BRIEF DESCRIPTION OF THE DRAWINGS

FIG. 1 is a block diagram showing the constitution of an embodiment of the WDM network design system according to the present invention;

FIG. 2 is a flow chart illustrating the operation of the embodiment of the WDM network design system according to the present invention;

FIG. 3 is a flow chart illustrating the operation of a path candidate combination design means 13 shown in FIG. 1;

FIG. 4 is a view showing topology example in an embodiment of the present invention;

FIG. 5 is a view showing disposition candidate links on topology in FIG. 4;

FIGS. 6 and 7 are views showing examples of predictive demands on the topology shown in FIG. 4;

FIG. 8 is a flow chart showing the crossover process in the path candidate combination design means 13 shown in FIG. 1;

FIG. 9 is a flow chart showing the mutation process in the path candidate combination design means 13 shown in FIG. 1; and

FIG. 10 is a flow chart showing the process in a path candidate design means in a different embodiment of the present invention.

### PREFERRED EMBODIMENTS OF THE INVENTION

Preferred embodiments of the present invention will now be described with reference to the drawings.

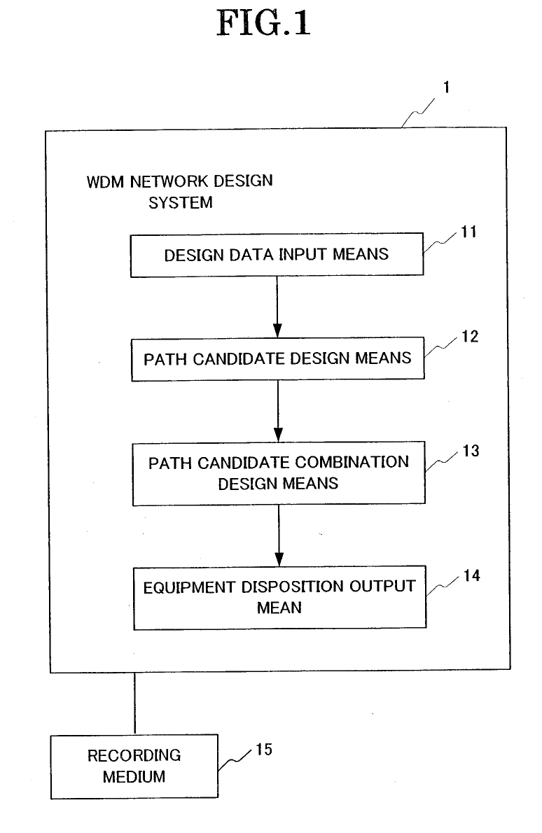

FIG. 1 is a block diagram showing the constitution of an embodiment of the WDM network design system according to the present invention. Referring to FIG. 1, the WDM network design system 1 is mainly constituted by a computer, and comprises a design data input means 11, a path candidate design means 12, a path candidate combination design means 13, an equipment disposition output means 14 and a recording medium 15. These means are realized by execution of program in the recording medium 15 in the personal computer.

To the design data input means 11 are inputted data of equipment candidates capable of being disposed, predictive demands and design parameters. The path candidate design means 12 designs a plurality of candidates of paths accommodating predictive demands by disposable equipment candidate based on the input data.

The path candidate combination design means 13 selects a combination of adequate paths among path candidates designed in the path candidate design means 12 by using a genetic algorithm in such a way as to permit an inexpensive WDM network to be built up. The equipment disposition output means 14 outputs a disposition of equipment accommodating the path combination selected in the path candidate combination design means 13.

The genetic algorithm is a means for obtaining a optimal solution of a given problem by using a genetic operation, which is based on a hint obtained in the process of evolution of organism.

By using this genetic algorithm, a theoretically optimal or near-optimal solution of any complicated problem is obtainable. For this reason, a number of application researches centered on project problems are in progress, and some systems are now in practical use. Also, with the genetic algorithm super-parallel computers are frequently used because of the fact that the algorithm is suited for parallel processing.

In the genetic algorithm, (1) a group of solution candidates (called identities) are generated, (2) the application degree of the individual identities is evaluated, (3) high evaluation value identities are selected, and (4) an identity group of the next generation is generated by carrying out such operations as crossover and mutation on the selected identities.

By repeatedly executing the operations in (2) to (4) for generation after another, high application degree identities are increased, and also the probability of appearance of identities closer to the optimal solution are increased. When a certain value is reached by the evaluation value in the above way, the solution at this time is the best value to be obtained.

The identities are each expressed by a column of genes arranged uni-dimensionally on chromosome. The crossover is an operation of serving a chromosome at an intermediate part thereof and connecting a part of another chromosome to the severed part. The mutation is an operation of replacing a part of character row with different characters.

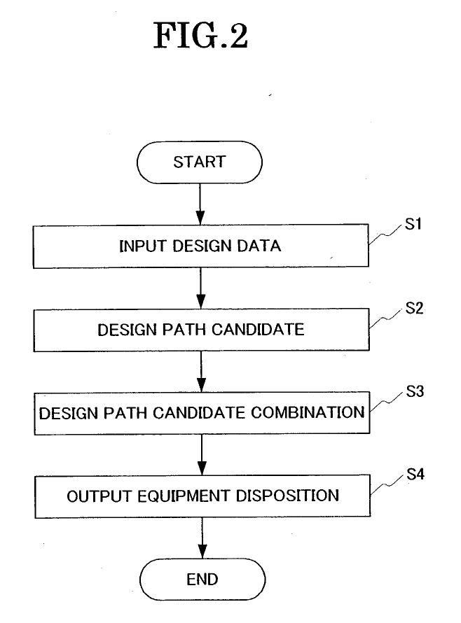

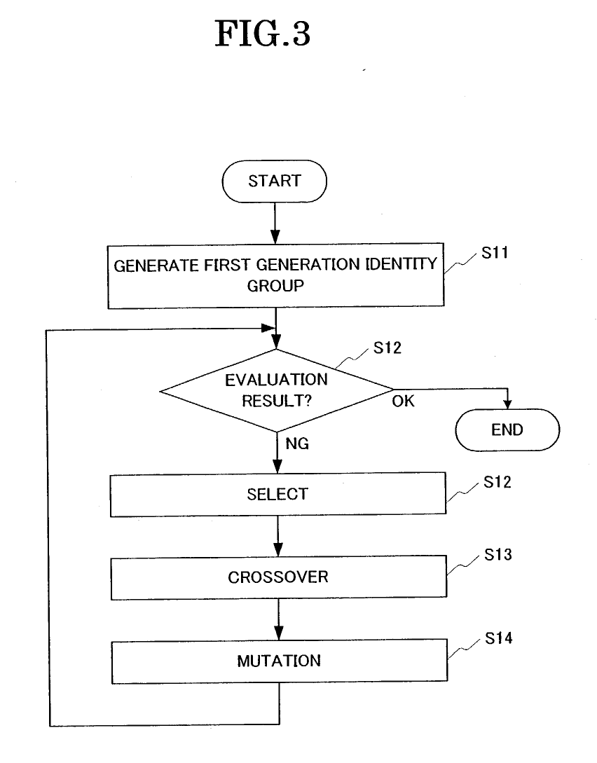

FIG. 2 is a flow chart illustrating the operation of the embodiment of the WDM network design system according to the present invention. FIG. 3 is a flow chart illustrating the operation of a path candidate combination design means 13 shown in FIG. 1. The operation of the embodiment of the WDM network design system according to the present invention will now be described with reference to FIGS. 1 to 3. The process routines shown in FIGS. 2 and 3 are realized as the computer executes program in the recording medium.

To the design data input means 11 are inputted a design equipment disposition candidate list, a predictive demand list and design input parameters (step S1 in FIG. 2). The equipment disposition candidate list is a list of links which are disposable when making inter-node connection. The links have as their attribute the maximum value of the number of wavelengths capable of being multiplexed (i.e., maximum multiplexing number) and the cost required for the disposition (i.e., disposition cost).

The predictive demand list is a list of demands predicted to be generated. The design parameters are desired cost, maximum path candidate number, number of identities per generation, number of design generations, number of crossovers per generation and mutation probability (i.e., probability of changing in gene array value per element).

The path candidate design means 12 designs at most n (n being a positive integer) paths connecting both ends of predictive demands by using such means as “Minimum Cost Path Retrieval System and Minimum Cost Path Retrieval Used for the Same” which is proposed by the applicant (step S2).

Subsequently, the path candidate combination design means 13 selects an appropriate path combination from the path candidates designed in the path candidate design means 12 by using a genetic algorithm (step S3).

The operation will now be described in details. First, the path candidate combination design means 13 generates identities corresponding in number to the number of identities per generation as first generation identities of genetic algorithm (first generation identity group generation) (step S11 in FIG. 3).

The path candidate combination design means 13 calculates (or evaluates) the equipment disposition cost as evaluation value of each identity (step S12 in FIG. 3). When the evaluation value of an identity having supreme evaluation value (here minimum equipment disposition cost) is below a desired cost, or the number of generations exceeds a design generation number, an end is brought to the process in the path candidate combination design means 13, and the routine goes to the process in the equipment disposition output means 14.

If the end requirement is not satisfied in the evaluation, the path candidate combination design means 13 compares the evaluation values of the individual identities, and deletes non-excellent identities, i.e., high evaluation value identities, leaving (or selecting) only the number of identities per generation (step S13 in FIG. 3).

The path candidate combination design means 13 executes gene array crossover by selecting arbitrary two of the identities remaining after the above selection process (step S14 in FIG. 3). This process is executed repeatedly a number of times corresponding to the number of crossovers per generation.

The path candidate combination design means 13 also executes mutation by selecting an arbitrary one of the identities remaining after the above selection process (step S15 in FIG. 3). In the mutation process, the value of each element in the gene array is randomly changed according to a preset mutation probability. This process is executed repeatedly a number of times corresponding to the number of mutations per generation.

The path candidate combination design means 13 re-executes the above evaluation process by making a total collection of the identities remaining after the selection process, the identities generated in the crossover process and the identities generated in the mutation process to be an identity collection for the next generation.

When the process in the path candidate combination design means 13 has been ended, the equipment disposition output means 14 outputs an equipment disposition based on best evaluation value identities (step S4 in FIG. 2), thus bringing an end to the WDM network design.

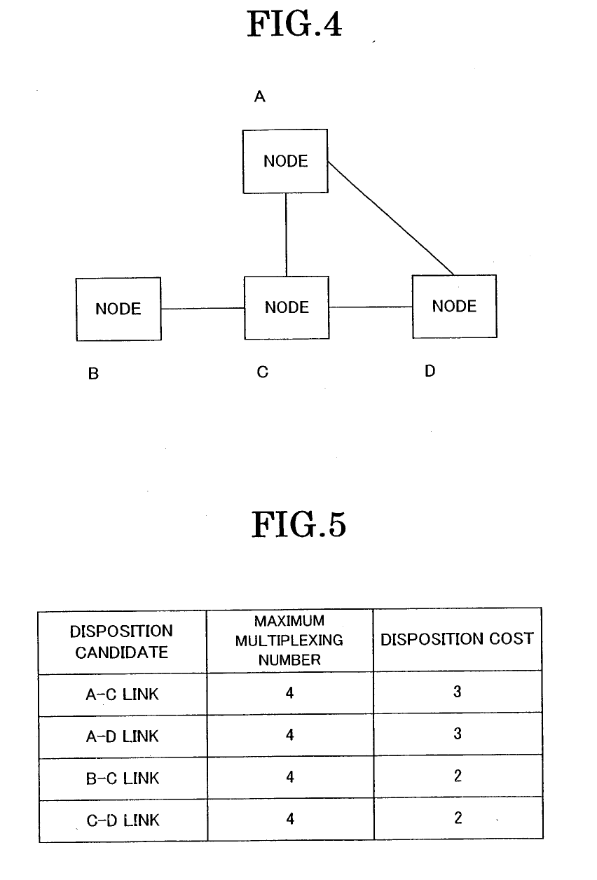

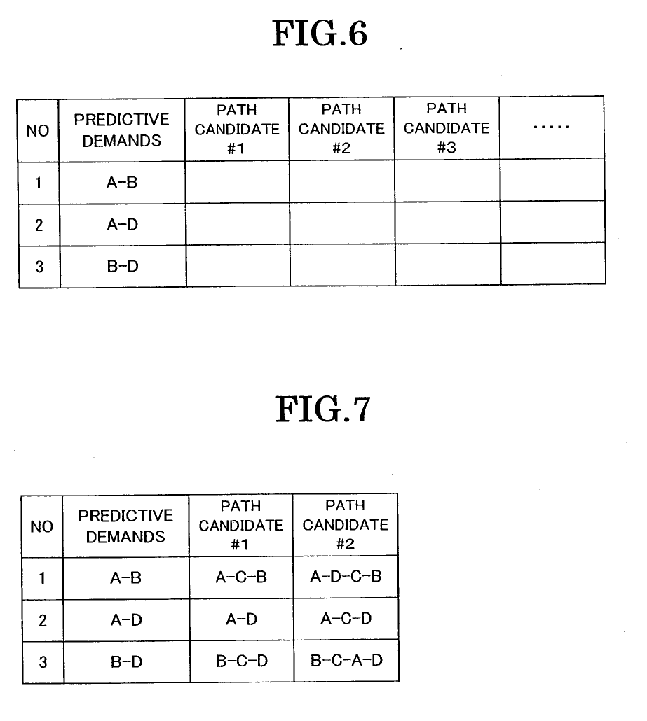

FIG. 4 is a view showing topology example in an embodiment of the present invention. FIG. 5 is a view showing disposition candidate links on topology in FIG. 4. FIGS. 6 and 7 are views showing examples of predictive demands on the topology shown in FIG. 4.

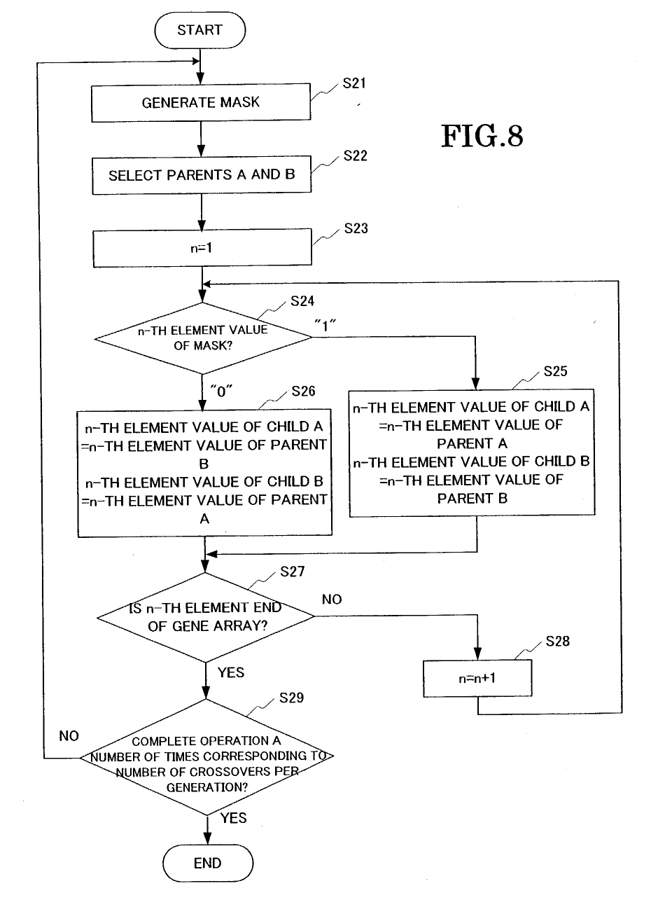

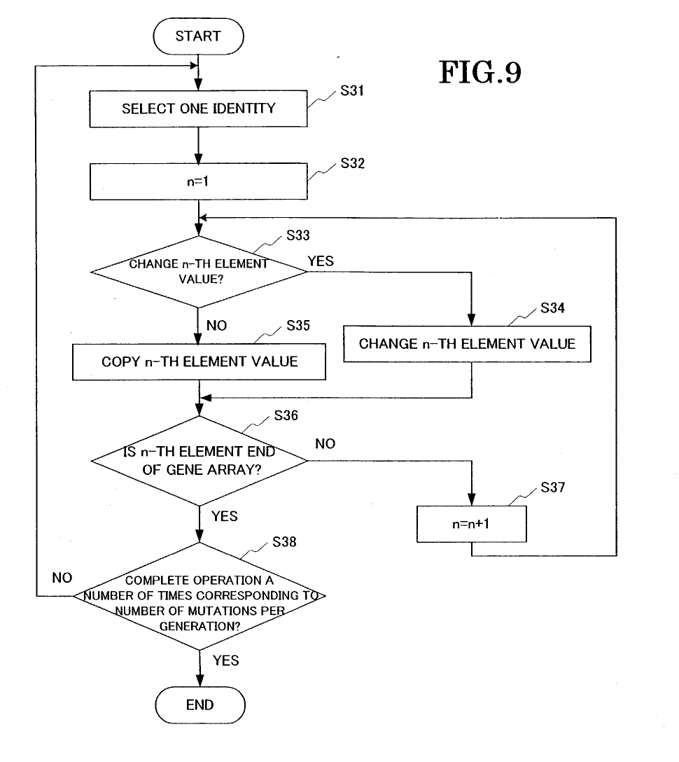

FIG. 8 is a flow chart showing the crossover process in the path candidate combination design means 13 shown in FIG. 1. FIG. 9 is a flowchart showing the mutation process in the path candidate combination design means 13 shown in FIG. 1. The processing of WDM network design in an embodiment of the present invention will be described concretely with reference to FIGS. 1 to 9. The processes shown in FIGS. 8 and 9 are realized with the execution of programs in the recording medium 15 by the personal computer.

FIG. 4 shows the way of constructing a topology, in which nodes A to D are interconnected with links, which each have each end provided with a WDM unit. FIG. 5 shows an assumption of disposition candidates as links directly connecting adjacent ones of the nodes A to D.

For each individual disposition candidate as link, the maximum number of wavelengths capable of being multiplexed in the link and the disposition cost thereof are preset. Specifically, for the disposition candidate “A-C link” the multiplex frequency number is preset to “4”, and the disposition cost to “3”. For the disposition candidate “A-D link” the maximum multiplex frequency number is preset to “4”, and the disposition cost to “3”. For the disposition candidate “B-C link” the maximum multiplex frequency number is preset to “4”, and the disposition cost to “2”. For the disposition candidate “C-Dlink” the maximum multiplex frequency number is “4”, and the disposition cost is “2”.

FIG. 6 shows an example of predictive demands on the topology shown in FIG. 4. As shown in FIG. 6, predictive demands “A-B”, “A-D” and “B-D” are assumed. The contents shown in FIGS. 5 and 6 and design parameters are inputted to the design data input means 11.

The path candidate design means 12 designs a plurality of path candidates for the predictive demands shown in FIG. 6 by utilizing the disposition candidate links shown in FIG. 5. FIG. 7 shows an example of the result of design of path candidates two for each demand with a maximum path candidate number of “2”.

The path candidate combination design means 13 generates identities of the genetic algorithm in a first generation group generation process (i.e., step S11 in FIG. 3). As the gene array for each identity is prepared one having elements corresponding in number to the number of predictive demands. In this example, three predictive demands are present as shown in FIG. 7, and thus gene arrays each having three elements are prepared.

The first element has its value as the path candidate number of A-B demand of predictive demand No. “1”. For the demand of predictive demand No. “1”, two path candidates “A-C-B” and “A-D-C-B” are designed in the path candidate design means 12, and either one of values “1” and “2” are randomly utilized. Here, it is assumed that the first element has value “1” with the selection of path candidate #1 (A-C-B).

Likewise assuming that path candidates #2 (A-C-D) and #1 (B-C-D) are selected as A-D and B-D demands of predictive demand Nos. “2” and “3”, respectively, the gene array of this identity is “1, 2, 1”.

As shown, the path candidate combination design means 13 generates identities in number corresponding to the number of identities per generation by randomly determining the value of the gene array, and sets the collection of these identities as first generation.

The path candidate combination design means 13 computes the equipment disposition cost as evaluation value of each identity in the evaluation process (i.e., step S12 in FIG. 3). For example, the equipment disposition cost of an identity having gene array of “1, 2, 1” is as follows.

Since the value of the first element is “1”, path (A-C-B) is selected for the predictive demand (A-B). For accommodating this predictive demand (A-B), dispositions of A-C and B-C links are necessary, and the total of these disposition costs is 3+2=5.

Since the value of the second element is “2”, path (A-C-D) is selected for predictive demand (A-D). Since the A-C link is already present and only the predictive demand (A-B) is utilized, even by adding the predictive demand (A-D), the resultant value is less than the maximum multiplex frequency number of “4”, and thus no additional disposition is necessary. Since no existing C-D link is present, now disposition of C-D link is necessary, and the addition cost is “2”. Thus, the total disposition cost up to this time is 3+2+2=7.

Finally, since the value of the third element is “1”, path (B-C-D) is selected for predictive demand (B-D). At this time, since the existing B-C and C-D links are present and also redundancy is present in the multiplex frequency number, no additional disposition is necessary. Thus, the total disposition cost is 3+2+2=7, and this value “7” is the evaluation value of the identity of the gene array “1, 2, 1”.

The path candidate combination design means 13 confirms an end condition after computing the evaluation values of all the identities. When the minimum evaluation value of the identity in this generation, the process in the path candidate combination design means is ended. Alternately, a generation number given as parameter is reached by the generation number of this time, the process in the path candidate combination design means is ended.

In the selection process (i.e., step S13 in FIG. 3), the path candidate combination design means 13 selects identities corresponding in number to the number of those per generation given as the parameter from upper rank ones, i.e., from smaller value identities in the evaluation, and deletes the other identities.

In the crossover process (i.e., step S14 in FIG. 3), the path candidate combination design means 13 randomly selects two identities (i.e., parent identities A and B) among the identities selected in the selection process, and generates new identities (i.e., child identities A and B) by using the two selected identities. The crossover process is executed as shown in FIG. 8.

In the crossover process, the path candidate combination design means 13 first generates a mask array (step S21 in FIG. 8). The mask array has the same length as the gene array of each identity, and as the value of each element either value “0” or “1” is randomly preset. The path candidate combination design means 13 selects two identities (i.e., parent identities A and B) among the identities selected in the selection process (step S22 in FIG. 8).

Subsequently, the path candidate combination design means 13, setting n=1 (step S23 in FIG. 8), determines the n-th element in the gene array of the child identities according to the n-th element of the mask (step S24 in FIG. 8).

When the value is “1”, the value of the n-th element of the child identity A is copied from the n-th element of the parent identity A, and the value of the n-th element of the child identity B is copied from the n-th element of the parent identity B (step S25 in FIG. 8). When the value is “0”, the value of the n-th element to be child identity A is copied from the n-th element of the parent identity B, and the value of the n-th element of the child identity B is copied from the n-th element of the parent identity A (step S26 in FIG. 8).

The path candidate combination design means 13 repeatedly executes the operation of the steps S24 to S26 until the end of the gene array (steps S27 and S 28 in FIG. 8), and then repeatedly executes the operation of the steps S21 to S28 a number of times corresponding to the number of crossovers per generation (step S29 in FIG. 8).

In the present example, it is assumed that the mask array length is “3”, and that the gene array is, for instance, “1, 0, 1”. It is also assumed that the gene arrays of the parent identities A and B are “1, 2, 1” and “2, 1, 1”. In this case, since the value of the first element of the mask array is “1”, the value “1” of the first element of the parent identity A is adopted for the first element of the child identity A. Also, since the value of the second element of the mask array is “0”, the value “1” of the second element of the parent identity B is adopted for the value of the second element. Likewise, the value “1” of the third element of the parent identity A is the value of the third element, and the gene array of the child identity A is “1, 1, 1”. Likewise, the gene array of the child identity B is “2, 2, 1”.

In the above crossover operation, identities corresponding in number to “(number of crossovers per generation)×2” are newly generated.

In the mutation process (i.e., step S15 in FIG. 3), the path candidate combination design means 13 randomly selects one identity (i.e., parent identity C) among the identities selected in the selection process, and generates a new identity (i.e., child identity C) by using the selected identity. The mutation process is executed as shown in FIG. 9.

In the mutation process, the path candidate combination design means 13 first randomly selects one identity (i.e., identity C) among the identities selected in the selection process (step S31 in FIG. 9), and operates the gene array of the identity (i.e., parent identity C) selected with n=1 (step S32 in FIG. 9).

The path candidate combination design means 13 makes a decision as to whether the value of the n-th element is to be changed according to a mutation probability given as parameter (step S33 in FIG. 9). When the value is to be changed, the means 13 randomly determines the value of the n-th element in the gene array of the child identity C step S34 in FIG. 9). When the value is not to be changed, the n-th element in the gene array of the parent identity C is directly coped to the child identity C (step S35 in FIG. 9).

The path candidate combination design means 13 repeatedly executes the operation of the steps S33 to S35 up to the end of the gene array of the parent identity C (steps S36 and S37 in FIG. 9), and then repeatedly executes the operation of the steps S31 to S37 a number of times corresponding to the number of mutations per generation (step S38 in FIG. 9).

In the above mutation operation, new identities corresponding in number to the number of mutations per generation are generated.

The path candidate combination design means 13 executes a re-evaluation process with an identity collection, which is obtained by adding the identities generated in the crossover process and the identities generated in the mutation process, as identity collection of the next generation.

When the process in the path candidate combination design means 13 has been ended, the equipment disposition output means 14 outputs an equipment disposition based on highest evaluation value identities (step S4 in FIG. 2), thus bringing an end to the WDM network design.

As has been shown, in this embodiment a plurality of predictive demand path candidates are designed, and paths are selected among the path candidates such as to provide for inexpensive equipment disposition cost. In this way, it is possible to design an inexpensive WDM network.

While the path candidate combination design means 13 solves the combination problem, it is possible to utilize the mechanism of the genetic algorithm shown in the steps S12 to S15 in FIG. 3 by realizing the gene array production in the preceding first generation identity collection generation process (i.e., step S11 in FIG. 3). It is possible, by using the genetic algorithm, to quickly design better combination even with a large-scale problem.

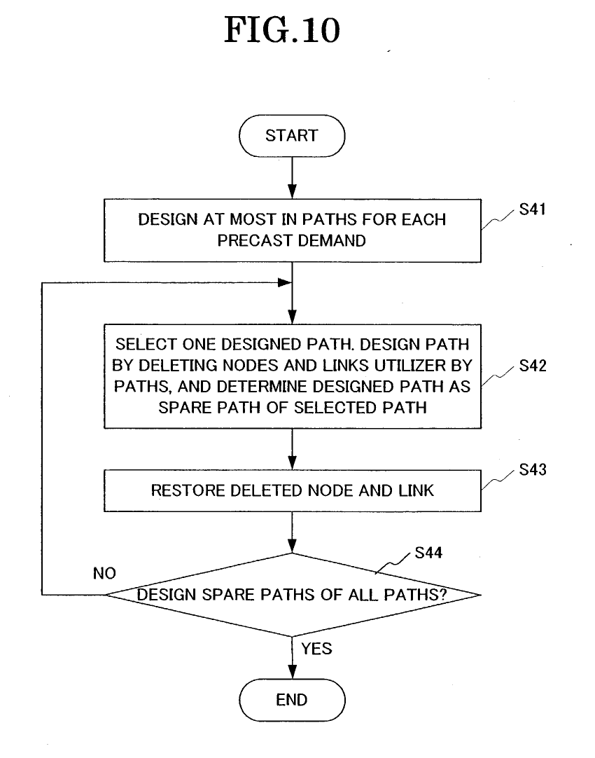

FIG. 10 is a flow chart showing the process in a path candidate design means in a different embodiment of the present invention. This embodiment of the WDM network design system according to the present invention is the same in construction as that of the first embodiment of the WDM network design system except for the operation process of the path candidate design means. The operation of this embodiment of the present invention will now be described with reference to FIGS. 1 and 10. The process shown in FIG. 10 is realized as computer executes a program stored in the recording medium 15.

As shown in FIG. 10, the path candidate design means 12 can design equipment disposition having backup paths as well into considerations by design the paths in use and the backup paths as pairs.

The path candidate design means 12 designs at most n paths for each predictive demand (step S41 in FIG. 10). The path candidate design means 12 designs paths by selecting one of the paths designed in the step S41, and deletes nodes and links utilized by these paths (step S42 in FIG. 10).

The paths designed here do not utilize the same nodes and links as the selected paths at all, and thus they can be utilized as backup paths in the case of trouble occurrence in a selected path. The path candidate design means 12 produces path pairs by using the selected paths as working paths and the designed paths as backup paths.

The path candidate design means 12 now restores the nodes and links which have been deleted in the step S42 (step S43 in FIG. 10). If non-designed paths for spare paths remain, the routine goes back to the step S42 (step S44 in FIG. 10).

As has been described in the foregoing, according to the present invention, a gene array is generated by design a plurality of candidates of paths for accommodating predictive demands by using the disposable equipment candidates, and an appropriate path combination is selected from the path candidates designed in the path candidate design by using a genetic algorithm, for obtaining the optimal solution of a given problem by executing a genetic operation with respect to the generated gene array. It is thus possible to quickly design better path combination even with any large-scale problem.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A WDM (wavelength division multiplexing) network design system comprising a path candidate design means for generating a gene array by design a plurality of candidates of paths for accommodating predictive demands by using a disposable equipment candidate, and a path candidate combination design means for selecting an appropriate path combination from path candidates designed in path candidate design by using a genetic algorithm for the optimal solution of a given problem by executing a genetic operation with respect to the generated gene array.

2. The WDM network design system according to claim 1, which further comprises a design data input means for inputting data of a disposable equipment candidate, predictive demands and design parameters.

3. The WDM network design means according to claim 1, which further comprises a equipment disposition output means for outputting a disposition of equipment for accommodating the path combination selected in the path candidate combination design means.

4. The WDM network design means according to claim 1, wherein in the genetic algorithm the network cost is utilized as identity evaluation value.

5. The WDM network design means according to claim 1, wherein the path candidate design means designs a pair of paths, i.e, path in use and backup path, as each path candidate.

6. A WDM (wavelength division multiplexing) network design method comprising steps of a path candidate design step for generating a gene array by design a plurality of candidates of paths for accommodating predictive demands by using a disposable equipment candidate, and a path candidate combination design step for selecting an appropriate path combination from path candidates designed in path candidate design by using a genetic algorithm for the optimal solution of a given problem by executing a genetic operation with respect to the generated gene array.

7. The WDM network design method according to claim 6, which further comprises a design data input step for inputting data of a disposable equipment candidate, predictive demands and design parameters.

8. The WDM network design method according to claim 6, which further comprises a equipment disposition output step for outputting a disposition of equipment for accommodating the path combination selected in the path candidate combination design means.

9. The WDM network design method according to claim 6, wherein in the genetic algorithm the network cost is utilized as identity evaluation value.

10. The WDM network design means according to claim 6, wherein the path candidate design step designs a pair of paths, i.e, path in use and backup path, as each path candidate.

11. A program for executing steps of a path candidate design step for generating a gene array by design a plurality of candidates of paths for accommodating predictive demands by using a disposable equipment candidate, and a path candidate combination design step for selecting an appropriate path combination from path candidates designed in path candidate design by using a genetic algorithm for the optimal solution of a given problem by executing a genetic operation with respect to the generated gene array.
